(19) United States
(12) Patent Application Publication
(10) Pub. No.: US 2012/0052230 A1
(43) Pub. Date: Mar. 1, 2012

(54) METHOD OF MANUFACTURING A FILM DRESSING

(75) Inventors: Esbjorn Olsson, Molndal (SE); Anders Dahlberg, Olofstorp (SE)

(73) Assignee: MOLNLYCKE HEALTH CARE AB, GOTEBORG (SE)

(21) Appl. No.: 13/320,071

(22) PCT Filed: May 11, 2010
(86) PCT No.: PCT/SE2010/050512

§ 371 Date: Nov. 11, 2011

(30) Foreign Application Priority Data
May 20, 2009 (SE) 0950362-4

(51) Int. Cl. B32B 33/00; B32B 38/04

(52) U.S. Cl. 428/41.8; 156/268

(57) ABSTRACT

Disclosed is a film dressing and a method of manufacturing a film dressing including the steps of feeding a composite web consisting of a first layer of thin plastic film and a second carrier layer releasably attached to the thin film, and a web of release material in a machine direction, applying a layer of adhesive onto the web of release material or onto the layer of thin plastic film, bringing together the composite web consisting of a first layer of thin plastic film with a second carrier layer and the web of release material after the layer of adhesive has been applied to either the web of release material or the layer of thin plastic film, cutting the web of release material along a line extending in the machine direction.

### TECHNICAL FIELD

The present invention relates to a method of manufacturing a film dressing comprising the steps of feeding, a composite web consisting of a first layer of thin plastic film and a second carrier layer releasably attached to the thin film, and a web of release material in a machine direction, applying a layer of adhesive onto the web of release material or onto the layer of thin plastic film, bringing together the composite web consisting of a first layer of thin plastic film and a second carrier layer with the web of release material after the layer of adhesive has been applied to either the web of release material or the layer of thin plastic film, cutting the web of release material along a line extending in the machine direction.

### BACKGROUND OF THE INVENTION

The adhesive coatings on dressings are usually covered by release sheets which have to be removed from the dressing before application of the dressing. The release sheets are necessary for enabling easy handling of the dressings before application and also for protecting the adhesive layer of the dressing from being contaminated by dust and other contaminants and for preventing dry-out of the adhesive. A common solution of the problem to enable easy removal of the release sheet is to make the release sheet in two parts, one of the parts having an edge bent to provide a grip flap and the other part overlapping the first part and its grip flap.

In film dressings, the film is so thin that it is impossible to handle both before application of the dressing and during application thereof if no support is available. In order to enable handling and application of the dressing after removal of the release sheet a stiffening layer is releasably attached to the thin film. After application of the dressing this stiffening layer is removed. For a film dressing, easy removal of both the release sheet and the stiffening layer is a requirement. In order to provide easy removal of the stiffening layer, this layer often has parts that extend beyond the extension of the film for forming grip tabs. Film dressings having release sheets and stiffening layers which both extend beyond the thin film of the dressing are known, see for example US 2004/0138603 A1. It is also known to affix separate grip tabs or the like to stiffening layers and release sheets.

Film dressings are often made by manufacturers that do not produce the films themselves but acquire the films from manufactures of plastic films. For ease of handling and processing such films are produced by co-extruding of the thin film and a carrier film of plastic material having poor affinity to each other so that the thin film easily can be removed from the carrier film or vice versa. Such carrier film can be used as a stiffening layer or carrier layer in a film dressing. However, if such carrier film is used as stiffening layer, no edge of the stiffening layer would extend beyond the edge of the thin film.

The objective of the present invention is to provide a method of manufacturing a film dressing, in which the release sheet and the stiffening layer are easy to remove without these layers extending beyond the thin film. It is also an objective of the present invention to provide such a method in which the release sheet can be applied as a single piece of material.

### SUMMARY OF THE INVENTION

These objectives are obtained by a method of manufacturing a film dressing comprising the steps of feeding, a composite web consisting of a first layer of thin plastic film and a second carrier layer relasably attached to the thin film, and a web of release material in a machine direction, applying a layer of adhesive onto the web of release material or onto the layer of thin plastic film, bringing together the composite web consisting of a first layer of thin plastic film and a second carrier layer with the web of release material after the layer of adhesive has been applied to either the web of release material or the layer of thin plastic film, cutting the web of release material along a line extending in the machine direction, characterised by the further step of weakening the first layer of thin film along a line coincident to the line cut in the web of release material. In such a method, the stiffening layer delivered by the manufacturer of the thin film can be used which considerably reduces waste of material. Furthermore, since the release sheet in a film dressing produced by this method is divided into two parts solely by a cut line, no folding of an edge of one part of the release sheet in order to form a grip tab is needed nor has the other part of the release sheet an overlapping edge. The web of release material can then be used as a so called process paper, i.e. a web onto which the adhesive layer and the composite of carrier layer and thin film can be laid, which simplifies the manufacture of dressings and reduces material waste.

According to a preferred embodiment the weakening line is a line of perforations and said the cutting line is a straight line. Said cutting line is preferably distanced 5-50 mm, preferably 10-30 mm from one of the edges of the web of release material. The distance between the perforations in the perforation line is 0.1-5 mm and the perforations in the perfotration line are preferably made through the whole composite web consisting of carrier material and a layer of thin plastic film. The release material is preferably silicone coated paper.

The invention also relates to a film dressing comprising a thin plastic film, a stiffening layer releasably attached to one side of the plastic film, a layer of adhesive applied to the plastic film on the side opposite to the stiffening layer and a release sheet covering the adhesive layer, wherein a cutting line extending along an edge of the dressing at a distance (d) therefrom is made through the release sheet, characterised in that a weakening line coincident to the cutting line in the release sheet is made in the plastic film.

According to a preferred embodiment, the weakening line is a perforation line, and the perforations in the perforation line preferably also penetrates the stiffening layer. The thin plastic film can be a polyurethane film and the stiffening layer can consist of polyethylene film. The adhesive in the adhesive layer can be an acrylate adhesive and the release sheet a silicone coated paper sheet. Alternatively, the adhesive in the adhesive layer can be a silicone adhesive and the release sheet a polyethylene sheet or a polypropylene sheet. In another alternative, the release sheet is a laminate of a paper sheet and a polyethylene sheet or a laminate of a paper sheet and a polypropylene sheet.

### BRIEF DESCRIPTION OF THE DRAWING

The invention will now be described with reference to the enclosed figures, of which;

FIG. 1 schematically discloses a side view of a manufacturing line for film dressings illustrating the method according to a preferred embodiment of the invention,

FIG. 2 schematically discloses a plan view from above of manufacturing line in FIG. 1,

FIG. 3 schematically shows a perspective view of a film dressing manufactured in the manufacturing line according to FIGS. 1 and 2, and

FIG. 4 schematically illustrates the first step in the application of a film dressing manufactured in the manufacturing line according to FIGS. 1 and 2.

### DESCRIPTION OF EMBODIMENTS

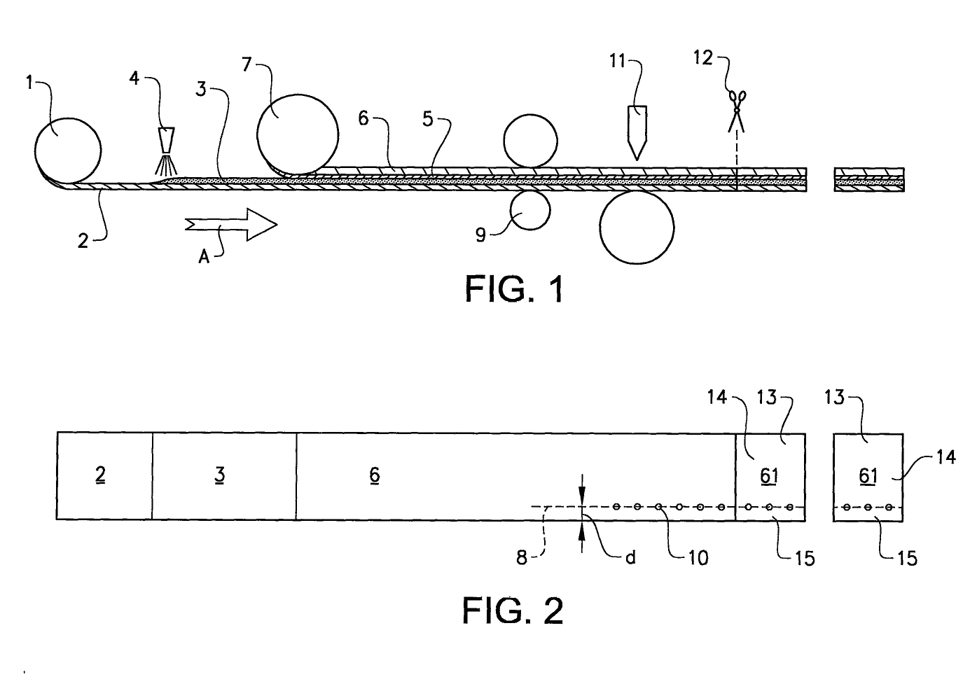

In FIGS. 1 and 2 a manufacturing line for continuous production of film dressings is schematically shown. A web 2 of release material is unwound from storage roll 1 and laid onto a conveyer (not shown) and transported on the conveyer in the direction of arrow A. An adhesive coating 3 is applied onto web 1 by a suitable glue applicator 4, which for example can be a blade coater or a slot nozzle. A composite web, consisting of a thin film 5 and a carrier layer 6 releasably attached to the film 5, is thereafter unwound from a storage roll 7 and laid onto the adhesive layer 3. A continuous line 8 extended in the machine direction, i.e. the transport direction of the conveyer, is then cut through the web 2 of release material without reaching into the film layer 5 with the aid of a suitable cutting tool 9, such as a rotating cutting device.

A line of perforations 10 is then made through the carrier layer 6 and the film layer 5 by any suitable means 11, such as a laser a ultrasonic device or a rotating cutting tool. Said perforation line is coincident to the cutting line 8.

Finally, the composite web consisting of layers 2,3,5,6 is transversely cut into single film dressings 13 with the aid of a suitable cutting device 12.

After manufacturing the film dressings 13 are transported to a packaging station (not shown in the figures).

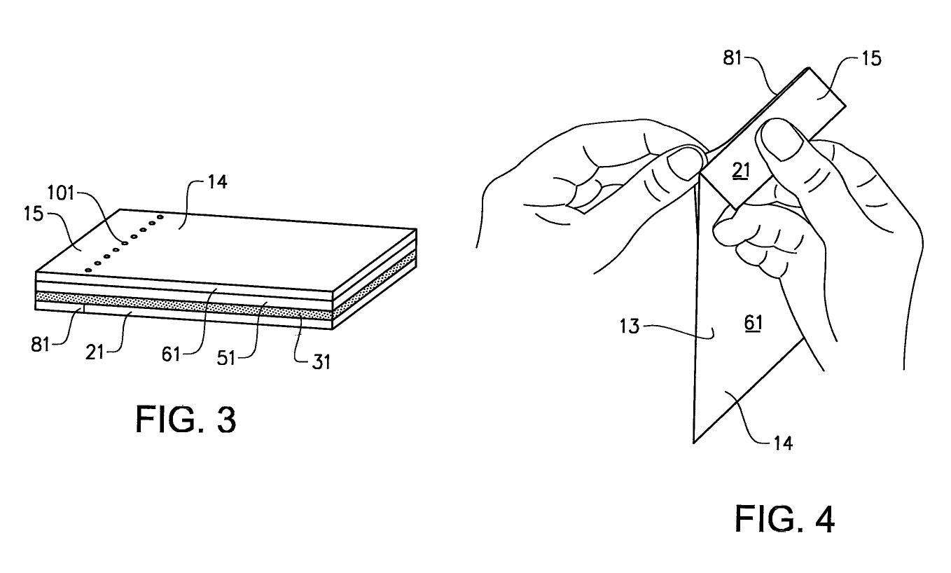

The layers in each film dressing 13 are given the same reference numerals as corresponding webs 2,3,5,6 with the addition of numeral 1. In FIG. 3 a film dressing 13 is shown in a perspective view. The carrier layer in film dressing 13 is referred to by numeral 61, the film layer by numeral 51, the layer of adhesive by numeral 31 and the release sheet by 21. The cutting line 81 and the coincident perforation line 101 divide each film dressing 13 into two parts 14 and 15, as can be seen in FIGS. 2 and 3. As will be explained later, part 15 serves as a grip part and has therefore a rather short extension perpendicular to the closest edge of the dressing directed in the machine direction, i.e. the direction indicated by arrow A. Preferably, the distance d from the closest edge of the dressing and the coincident lines 8,10 is 5-50 mm. and more preferably 10-30 mm.

In FIG. 4, an example of how the first step in the application of a film dressing 13 can be performed is schematically illustrated. The dressing 13 is gripped in part 15 with one hand, the right hand in FIG. 4, and held so that part 14 is allowed to form an angle with part 15 by gravity. The release sheet 21 of dressing 13 should be turned upwards as illustrated in FIG. 4. If needed, the free left hand can be used to fold part 14 downward. With the dressing 13 in this position, as illustrated in FIG. 4, it is easy for the user to release an upper corner of the release sheet from the rest of part 14 by slightly moving the part 14 upwards in relation to part 15 thereby releasing a small upper part of the release sheet from the film or by loosening the release sheet from the thin film by peeling with a thumb. The released corner is then gripped between the fingers of the left hand and wholly or partly removed from the rest of part 14. If partly removed, the part of dressing 13 having an uncovered adhesive area is then attached to the skin and the remaining part of the release sheet of part 14 is then removed during attaching of the thereby uncovered adhesive area. After having attached the dressing, the carrier layer 61 is then removed from the thin film. The outermost part of the carrier layer 61, the part in proximity to the perforation line, has in the method of manufacture been lifted so that a small portion of the carrier layer is no longer attached to the thin film thereby providing an easily grasped flap for removal of the carrier film. After removal of the carrier layer 61, the remaining portion of part 15, i.e. a portion of the release sheet and the thin film attached thereto is firmly gripped. Thereafter, the film attached to the release sheet in part 15 of the dressing is removed from the part of the film attached to skin, i.e. the portion of the film located in part 14, by tearing along the perforation line, and the release sheet in part 15 and the portion of the film attached thereto are then discarded.

In order to provide an easy tearing of the film in part 15 of the dressing the distance between adjacent perforations in the perforation line 101 should be 0.1-5 mm.

In FIG. 4, the angle between parts 14 and 15 of dressing 13 is large. This is not necessary, the corners of release sheet 21 on part 14 are easily released and gripped even if the angle is smaller.

Thus, by the described method a film dressing which is easy to handle and apply to skin is produced. Moreover, due to the stiffening characteristics of the carrier the dressing can be cut into any suitable shape by the user of the dressing 13 provided that at least a part of the connection between parts 14 and 15 of dressing 13 is unbroken.

As stated above, the composite web consisting of a thin film 5 and a carrier layer 6 delivered from the manufacturer of the film is used in the method according to the invention. Thereby, a removal of this carrier layer and an application of another carrier layer by heat and pressure or adhesive is not necessary in the manufacturing method according to the present invention. Furthermore, since the release sheet is divided into two parts solely by a cutting line, there is no need to remove the web 2 of release material and apply a web of release material consisting of two parts, one part having an edge fold and the other part having an edge portion overlapping said fold. The method according to the present invention thus allows an efficient use of materials without any waste of material in the manufacturing line.

The web 2 of release material is preferably a web of silicone coated paper of the type commonly used as release sheet material in wound dressings. However, any material used as release material in wound dressings, such as plastic foil material, can be used. An example of a suitable material is silicone coated paper with the trade name Lopasil CCK from Loparex BV, Apeldoorn, NL. Since the release material should be easily removable from the adhesive coating 3, the choice of release material is dependent on the adhesive used in the dressing. If, for example, a silicone adhesive is used, a silicone coated material is unsuitable and known release materials for dressings having silicone adhesive is used, such as a web of polyethylene, a laminate of paper and polyethylene or a laminate of paper and polypropylene.

The adhesive layer 3 is preferably a layer of acrylate adhesive or hot melt. A suitable adhesive is Dispomelt® 70-4647 from National Starch and Chemical Company, Bridgewater, N.J., USA. Other adhesives known to be used in wound dressings, such as silicone adhesives, can also be used.

The thin film 5 having a thickness less than 70 micrometer is preferably of polyurethane. A suitable film is Platilon® 2202 from Epurex Films Gmbh & Co KG, Bomlitz, Germany. Such a film is delivered carried on a web of polyethylene. Other types of film materials used for film dressings can also be used delivered carried by webs of carrier material.

The carrier layer 6 is of a material which is easily removable from the film 5 and is thus dependable of the film material. For a polyurethane film, a carrier of polyethylene is suitable. All known combinations of films and carrier material for film dressings can be used in the present invention.

In the embodiment according to FIGS. 1 and 2 the adhesive layer is applied to the web of release material. In another embodiment (not shown) the adhesive layer can instead be applied onto the thin film of the composite web consisting of a carrier material and a thin film delivered from the film manufacturer. A web of release material is then laid onto the the adhesive layer applied on the thin film. Thereafter, the cutting steps described in connection with the embodiment according to FIGS. 1 and 2 are performed, the only difference being that the cutting of the continuous line in the web of release material is performed from above instead of from below as in FIG. 1 and the perforation is made from below instead of from above.

The last step of transverse cutting to form individual film dressings is omitted if the produced film dressing is to be wound up onto a roller as a continuous film dressing.

It is preferred that the perforation line 10 and the cutting line 8 through the web of release material are perfectly aligned with each other but this is not strictly necessary. A difference of up to one or two millimetres can be allowed without seriously impairing the function of the end product.

It is also preferred that the cutting line and thereby also the perforation line is straight. However, these lines can be curved, for example having wave form, or have curved parts.

For ease of manufacturing, the perforation line 10 is described as passing trough both the carrier layer 6 and the film layer 5. However, it is only necessary that the perofration line passes through the film layer 5. It is thus possible, but not preferred, to produce the perforation line from below so that it only passes through the film layer 5.

Instead of a perforation line, another type of weakening line can be cut into the film. Such a line can be made simultaneously with the cutting of the continuous line through the web of release material just by making a deeper cut. Such a cut should reach into 15-75% of the thickness of the film on order to make the film easily tearable, depending of the htickness and mechanical strength of the film.

It is pointed out that even if the method had been developed for manufacturer of film dressings that themselves do not manufacture films, the method is not restricted thereto. A manufacturer of films can of course also be manufacturing film dressings. It is also possible to make the manufacturer of films to use a specific carrier material chosen by the manufacturer of film dressings. The use of the carrier material that the film is delivered with in the present manufacturing method is thus not per se restrictive for the choice of carrier material.

The embodiment described with reference to the figures can of course be modified without leaving the scope of invention. For example, the carrier layer 6 stiffening the film 5 can be divided into two or more parts by a cutting line by equipment similar to the equipment used for cutting line 8. The perforation of the release layer 6 and the film 5 can be made before the step of cutting line 8 through the release web 2. The scope of invention shall therefore only be restricted by the content of the enclosed patent claims.

1. A method of manufacturing a film dressing comprising the steps of feeding, a composite web consisting of a first layer of thin plastic film and a second carrier layer relasably attached to the thin film, and a web of release material in a machine direction, applying a layer of adhesive onto the web of release material or onto the layer of thin plastic film, bringing together the composite web consisting of a first layer of thin plastic film and a second carrier layer with the web of release material after the layer of adhesive has been applied to either the web of release material or the layer of thin plastic film, cutting the web of release material along a line extending in the machine direction, characterised by the further step of weakening the first layer of thin film along a line coincident to the line cut in the web of release material.

2. The method according to claim 1, wherein the weakening line is a line of perforations.

3. The method according to claim 1, wherein the cutting line is a straight line.

4. The method according to claim 1, wherein said cutting line is distanced 5-50 mm, preferably 10-30 mm from one of the edges of the web of release material.

5. The method according to claim 2, wherein the distance between the perforations in the perforation line is 0.1-5 mm.

6. The method according to claim 2, wherein the perforations in the perforation line are made through the whole composite web consisting of carrier material and a layer of thin plastic film.

7. A film dressing comprising a thin plastic film, a stiffening layer releasably attached to one side of the plastic film, a layer of adhesive applied to the plastic film on the side opposite to the stiffening layer and a release sheet covering the adhesive layer, wherein a cutting line extending along an edge of the dressing at a distance therefrom is made through the release sheet, characterised in that a weakening line coincident to the cutting line in the release sheet is made in the plastic film.

8. The film dressing according to claim 7, wherein the weakening line is a perforation line.

9. The film dressing according to claim 8, wherein the perforations in the perforation line also penetrates the stiffening layer.

10. The film dressing according to claim 7, wherein the thin plastic film is a polyurethane film and the stiffening layer consists of polyethylene film.

11. The film dressing according to claim 7, wherein the adhesive in the adhesive layer is an acrylate adhesive and the release sheet is a silicone coated paper sheet.

12. The film dressing according to claim 7, wherein the adhesive in the adhesive layer is a silicone adhesive and the release sheet is a polyethylene sheet or a polypropylene sheet.

13. The film dressing according to claim 12, wherein the release sheet is a laminate of a paper sheet and a polyethylene sheet or a laminate of a paper sheet and a polypropylene sheet.
